(19) United States
(12) Patent Application Publication
(10) Pub. No.: US 2018/0259643 A1
(43) Pub. Date: Sep. 13, 2018

(54) SONAR DEVICE

(71) Applicant: MOKPO NATIONAL MARITIME UNIVERSITY INDUSTRY-UNIVERSITY COOPERATION FOUNDATION, Mokpo-si (KR)

(72) Inventors: Sang Hoon KIM, Mokpo-si (KR); Yeon Seong CHOO, Mokpo-si (KR)

(73) Assignee: MOKPO NATIONAL MARITIME UNIVERSITY INDUSTRY- UNIVERSITY COOPERATION FOUNDATION, Mokpo-si (KR)

(21) Appl. No.: 15/822,108

(22) Filed: Nov. 24, 2017

(30) Foreign Application Priority Data
Mar. 8, 2017 (KR) 10-2017-0029331

(51) Int. Cl. G01S 15/93; G01S 3/808; G01S 15/06

(52) U.S. Cl. CPC G01S 15/93; G01S 15/06; G01S 3/8083

(57) ABSTRACT

Disclosed is a sonar device including an upper plate, a lower plate disposed in parallel with the upper plate so as to be spaced apart from the upper plate, a plurality of refraction parts connected between the upper plate and the lower plate so as to refract sound waves, a plurality of sensor parts disposed between the upper plate and the lower plate so as to sense the sound waves passed through the refraction parts, and an output unit to visually or audibly output an intensity or direction of the sound waves sensed by the sensor parts.

### CROSS-REFERENCE TO RELATED APPLICATION

This application claims the benefit of Korean Patent Application No. 10-2017-0029331, filed on Mar. 8, 2017, which is hereby incorporated by reference as if fully set forth herein.

### BACKGROUND OF THE INVENTION

### Field of the Invention

The present invention relates to a sonar device, and more particularly, to a sonar device which may observe direction and movement of a sound source by implementing Luneburg lens technology acoustically.

### Discussion of the Related Art

In general, ships are equipped with radar so as to detect positions and directions of surrounding ships. Nevertheless, in heavy fog or when visibility is very poor, ships do not leave a port and, even if a ship leaves a port, the ship takes shelter in another nearby port. Ships may detect positions of other ships through radar and thus sail regardless of visibility, but radar does not have a warning function. Therefore, if good visibility is not secured, a risk of accident occurrence is rapidly increased unless a mate observes a necessary point at a necessary time.

Ships have various sizes and may thus have stopping distances of several km and, if a collision takes place at sea, the scale of damage is great. Every year, several tens of collisions between large vessels with a displacement of tens of thousands of tons occur, and collisions between small ships are innumerable.

For this reason, all ships should be equipped with a whistle generator which sounds whistle and thus informs surrounding ships of the position thereof so as to prevent collision, in the same manner as a horn for vehicles, and the whistle generator uses two kinds of signals, i.e., a short sound (1 second) and a long sound (4-6 seconds), based on international treaties.

A mate, if visibility is poor, should inform other ships of the position of his/her own ship through a whistle and judge the positions of the ships using whistles generated from the ships and, at this time, has difficulty precisely detecting approach directions of the ships using only his/her hearing. Particularly, if the mate hears whistles from two or more places, a lot of experience and know-how are required to detect the positions of the ships.

Therefore, advanced countries have developed a Sound Reception System (SRS) and have implemented the same. The SRS is a system which includes four microphones installed at the front, rear and both sides of a ship and detects the direction of a sound source by calculating vectors through comparison among sounds input through the respective microphones.

However, such an SRS has difficulty detecting the correct directions of sound sources if whistles are generated from two or more places, and the SRS is an electronic device and, thus, if the SRS malfunctions, it is difficult to repair the SRS. Further, the SRS is expensive and is thus difficult to popularize.

### SUMMARY OF THE INVENTION

Accordingly, the present invention is directed to a sonar device that substantially obviates one or more problems due to limitations and disadvantages of the related art.

An object of the present invention is to provide a sonar device which may precisely detect a direction of a whistle transmitted from a ship, a distance to a sound source (the ship generating the whistle) or a proceeding direction or a turning direction of the sound source using Luneburg lens (also referred to as acoustic meta lens) technology, and precisely judge directions of sound sources received from two or more places.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a sonar device includes an upper plate, a lower plate disposed in parallel with the upper plate so as to be spaced apart from the upper plate, a plurality of refraction parts connected between the upper plate and the lower plate so as to refract sound waves, a plurality of sensor parts disposed between the upper plate and the lower plate so as to sense the sound waves passed through the refraction parts, and an output unit to visually or audibly output an intensity or direction of the sound waves sensed by the sensor parts.

The refraction parts may be formed of a material having different impedance from air or water.

The refraction parts may refract a medium passing between the refraction parts by changing an elastic modulus or density of the medium.

Diameters or cross-sectional areas of the refraction parts may be gradually decreased in a direction from a central region of a space between the upper plate and the lower plate to an edge region of the space, or paths of the refraction parts to pass the sound waves may be gradually broadened in the direction from the central region of the space to the edge region of the space.

Refractive indexes of the refraction parts may be gradually decreased in the direction from the central region of the space between the upper plate and the lower plate to the edge region of the space so that a velocity of the sound waves is increased and the sound waves introduced into one side of the space is collected at the other side of the space.

The refraction parts may be formed to have a column shape connecting a lower surface of the upper plate to an upper surface of the lower plate, and have a circular, oval or polygonal, such as triangular, cross-section.

The sensor parts may be located close to side surfaces of the refraction parts at an edge region of a space between the upper plate and the lower plate, and be disposed at an equal interval or at an equal angle.

The sonar device may further include a controller configured to receive sound wave signals sensed by the sensor parts located at designated positions, to convert the sound wave signals into electrical signals and then to transmit the electrical signals to the output unit.

The sonar device may further include a transceiver unit configured to transmit sound waves at a current position of the sonar device and then to cause echo sound waves from a target to be received by the refraction parts.

The controller may be operated through at least one of an active control method to transmit sound waves through the transceiver unit and to receive echo sound waves, and a passive control method to receive sound waves generated from the outside.

If the controller is operated through an active control method, the controller may control the output unit to output at least one of a distance between a current position of the sonar device and a target and a direction and a velocity of the target.

If the sensor parts sense sound waves from two or more targets, the controller may control the output unit to simultaneously output data sensed by the sensor parts.

It is to be understood that both the foregoing general description and the following detailed description of the present invention are exemplary and explanatory and are intended to provide further explanation of the invention as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a sonar device in accordance with one embodiment of the present invention;

FIG. 2 is a perspective view of the sonar device shown in FIG. 1;

FIG. 3 is a reference view illustrating positions of sensor parts of the sonar device shown in FIG. 2;

FIG. 4 is a reference view illustrating positions of refraction parts of the sonar device shown in FIG. 2;

FIG. 5 is an enlarged reference view illustrating some of the refraction parts of the sonar device shown in FIG. 4; and

FIG. 6 is a reference view illustrating a focusing state of the sonar device shown in FIG. 1, in which sound waves are refracted, through computer simulation.

### DETAILED DESCRIPTION OF THE INVENTION

Reference will now be made in detail to the preferred embodiments of the present invention, examples of which are illustrated in the accompanying drawings. In the drawings, the same or similar elements are denoted by the same reference numerals even though they are depicted in different drawings. In the following description of the present invention, a detailed description of known functions and configurations incorporated herein will be omitted when it may make the subject matter of the present invention rather unclear. Those skilled in the art will appreciate that any features illustrated in the drawings may be enlarged, reduced or simplified for ease of description, and the drawings and elements thereof are not always illustrated to scale.

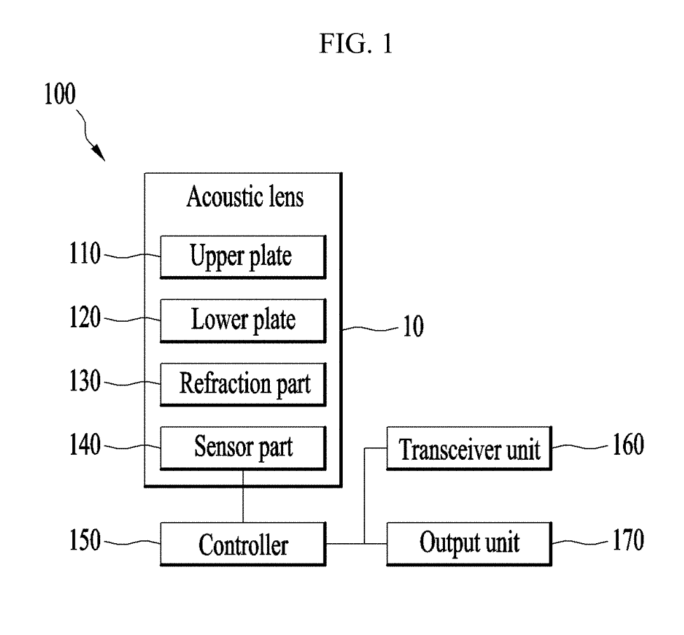

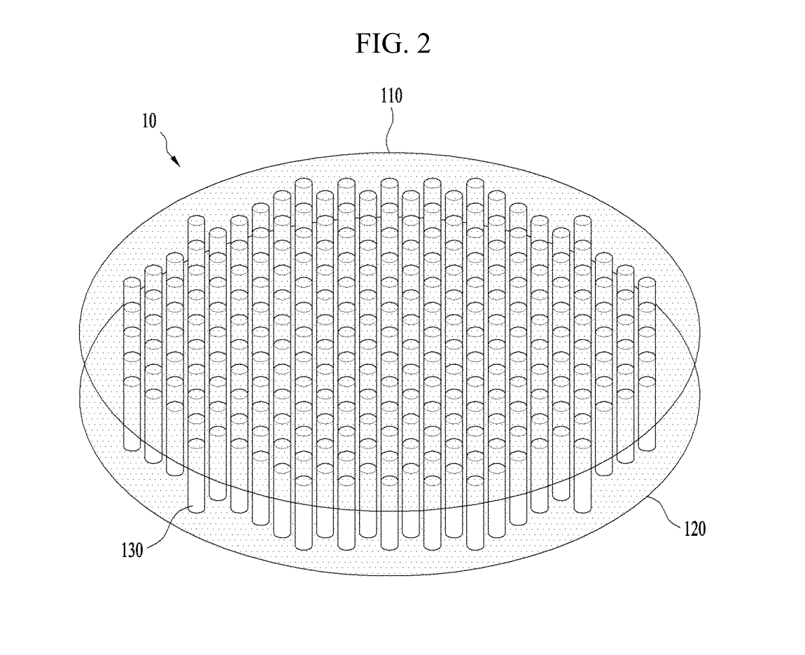

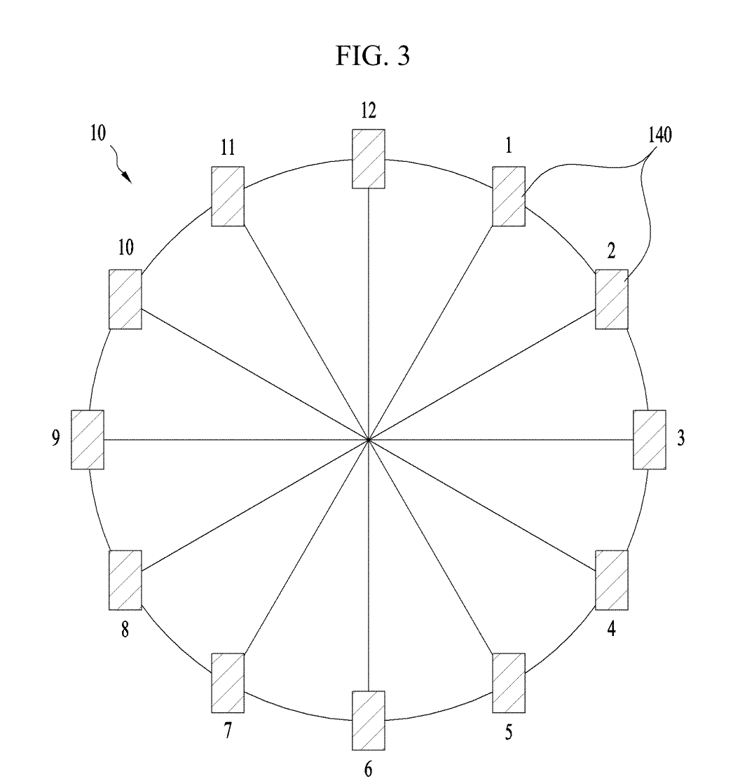

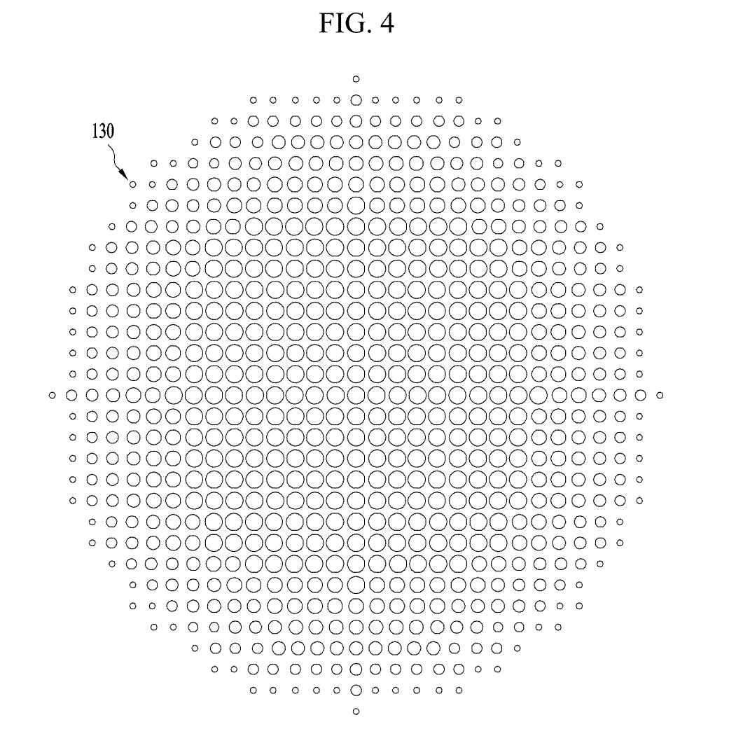

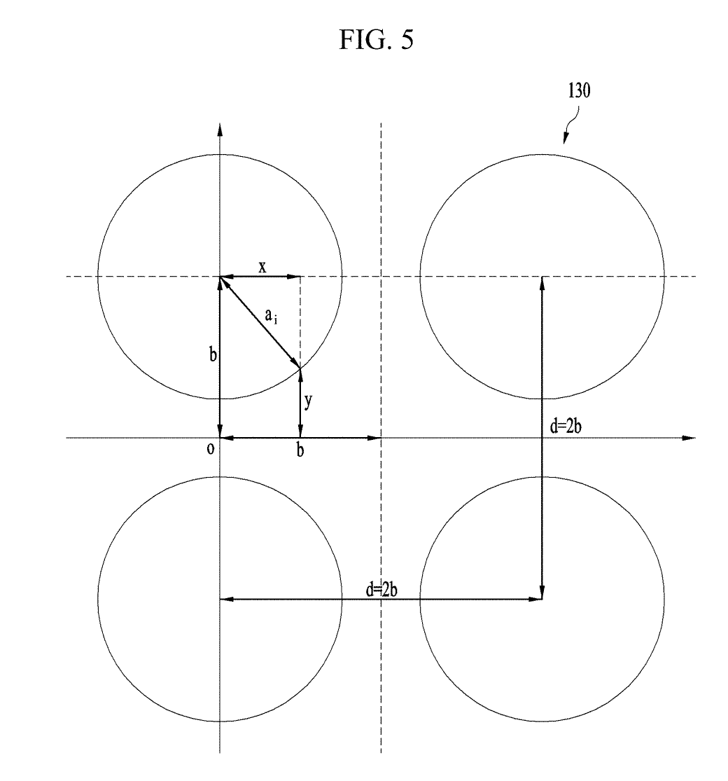

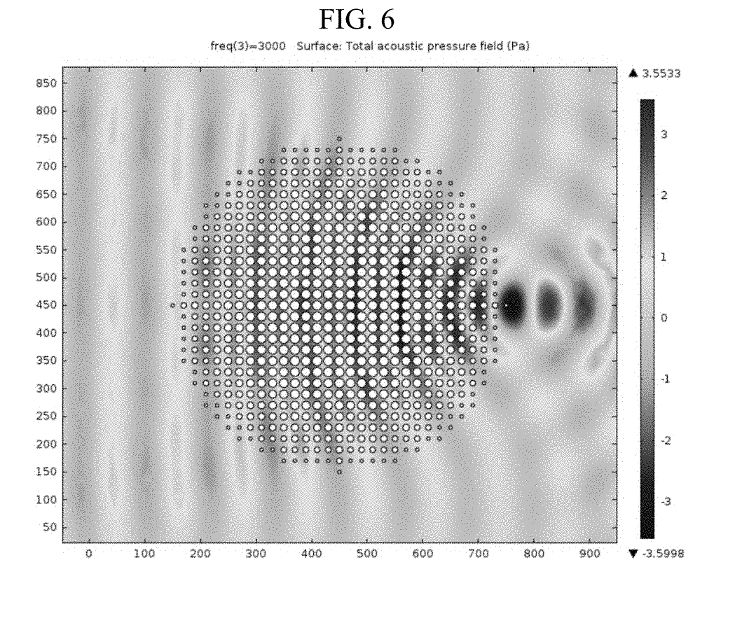

FIG. 1 is a block diagram illustrating a sonar device in accordance with one embodiment of the present invention, FIG. 2 is a perspective view of the sonar device shown in FIG. 1, FIG. 3 is a reference view illustrating positions of sensor parts of the sonar device shown in FIG. 2, FIG. 4 is a reference view illustrating positions of refraction parts of the sonar device shown in FIG. 2, FIG. 5 is an enlarged reference view illustrating some of the refraction parts of the sonar device shown in FIG. 4, and FIG. 6 is a reference view illustrating a focusing state of the sonar device shown in FIG. 1, in which sound waves are refracted, through computer simulation.

With reference to FIGS. 1 to 6, a sonar device in accordance with one embodiment of the present invention is formed to have a cylindrical shape or a disc shape and includes an upper plate 110, a lower plate 120 disposed in parallel with the upper plate 110 so as to be spaced apart from the upper plate 110, a plurality of refraction parts 130 connected between the upper plate 110 and the lower plate 120 so as to refract sound waves, sensor parts 140 disposed between the upper plate 110 and the lower plate 120 so as to sense the sound waves passed through the refraction parts 130, an output unit 170 to visually or audibly output an intensity or direction of the sound waves sensed by the sensor parts 140, a controller 150 which receives sound wave signals sensed by the sensor parts located at designated positions, converts the sound wave signals into electrical signals and then transmits the electrical signals to the output unit 170, and a transceiver unit 160 which transmits sound waves at a current position of the sonar device 100 and then causes echo sound waves from a target to be received by the refraction parts 130.

The upper plate 110 and the lower plate 120 are formed in a thin circular flat shape and combined with a position of a ship for holding the sonar device 100, for example, an upper surface of a deck of the ship (in air) or a bottom surface of the deck of the ship (underwater).

The sonar device 100 may be located in air so as to detect a whistle, or located underwater so as to detect sound waves transmitted and received underwater.

Further, the refraction parts 130 are parts, through which sound waves pass. Sound waves introduced into one side of the sonar device 100 are refracted to one point of the other side of the sonar device 100 while passing through the refraction parts 130, thus being focused. Here, at the interface between two materials at the edge of the refraction part 130, impedances of the two materials maximally coincide with each other and, thus, reflected waves may be reduced.

The refraction parts 130 may be formed to have a column shape connecting a lower surface of the upper plate 110 to an upper surface of the lower plate 120, and have a circular, oval or polygonal, such as triangular, cross-section. Further, the refraction parts 130 are formed of a material having different impedance from air or water (acoustic impedance=density×velocity). The material of the refraction parts 130 may be a synthetic resin, such as plastic, glass, wood, or a metallic material, having greater impedance than air in air. Further, the material of the refraction parts 130 may be a metallic material, air or vacuum having greater impedance than water in water. Of course, any material having greater impedance than air or water may be employed as the refraction parts 130 according to application environment.

Here, an assembly of the upper plate 110, the lower plate 120 and the refraction parts 130 is referred to as an acoustic lens 10. As sound waves pass through the refraction parts 130 of the acoustic lens 10, the sound waves should be focused onto one point. For this purpose, the refraction parts 130 must have different refractive indexes according to position. Such a lens 10 is referred to as a gradient index (GRIN) lens.

If waves incident upon one side of the circular acoustic lens 10 having a radius a in air are completely focused onto one point at the edge of the other side of the acoustic lens 10 without aberration, a refractive index is calculated as a function of radius, as stated in Equation 1 below.

$$n ( r ) = \sqrt{2 - {( \frac{r}{a} )}^{2}} \qquad [ Equation 1 ]$$

Here, a is a radius of the acoustic lens 10, r is a radius of the refraction parts 130, and 0≤r≤a. The center of the acoustic lens 10 has the greatest refractive index of 1.414, and the edge of the acoustic lens 10 has the same refractive index as air, i.e., 1. Therefore, the velocity of sound waves entering the center of the acoustic lens 10 is decreased and the velocity of sound waves entering the edge of the acoustic lens 10 is increased, and, thus, the sound waves are focused onto one point at the edge of the other side of the acoustic lens 10 without aberration. As the sound waves are collected at the edge of the other side of the acoustic lens 10, the amplitude of a sound intensity is doubled to quintupled and a sound volume is increased to about 10 dB or more, and, thus, a focus region may be distinguishable from other regions and a direction of a sound source may be detected. Further, since an amplitude of the sound source to be focused is increased when the sound source is close to the acoustic lens 10 and is decreased when the sound source is distant from the acoustic lens 10, movement of the sound source may be detected. An acoustic Luneburg lens is acoustically implemented by adjusting a velocity of sound waves. The velocity of sound waves is calculated by a function of bulk modulus (elastic modulus of a medium; B) and density p of air, as stated in Equation 2 below.

$$v = \sqrt{\frac{B}{p}} \qquad [ Equation 2 ]$$

Here, elastic modulus B is a function of air pressure and is almost a constant in the refraction parts 130. Therefore, when the density of air is adjusted, the velocity is changed and, thus, the refractive index is changed according to density, as stated in Equation 3 below.

$${n}_{i} = \frac{{v}_{o}}{{v}_{i}} = \sqrt{\frac{{ρ}_{i}}{{ρ}_{o}}} \qquad [ Equation 3 ]$$

Here, i is a refractive index of an i^{th} position from the center of the acoustic lens 10 because the refractive index is a function of radius and is thus equal along a concentrically circle. vₒ is a background velocity and po is a background density.

Further, the acoustic lens 10 is configured such that the central part of the acoustic lens 10 forms narrow paths, along which sound waves pass, and thus increases the density of air. Further, the edge part of the acoustic lens 10 forms broad paths, along which sound waves pass, and thus decreases the density of air. Therefore, incident sound waves have different velocities within the acoustic lens 10 and are thus refracted. Here, the refracted sound waves are precisely gathered at the other side of the acoustic lens 10, a position where sound waves are gathered has higher sound pressure than other positions where sound waves are not gathered, and thus a larger amount of current flows in the sensor parts 140 close to such the position where sound waves are gathered. When the controller 150 converts sound signals into optical signals using current at the sensor parts 140 close to the position where sound waves are gathered, an image of the sound source may be displayed to a user through the output unit 170.

Sound waves exiting from the edge part of the acoustic lens 10 are converted into plane waves after passing through the acoustic lens 10 due to reversible phenomenon of waves and, thereby, the sonar device 100 in accordance with the present invention may be selectively used as a passive sonar device or an active sonar device.

Here, passive sonar systems acquire information regarding a target by receiving only sound waves generated by the target without artificially transmitting sound waves, and the passive sonar systems are mainly used for military purpose to detect submarines. As representative passive sonar systems, there are a sound surveillance system (SOSUS) installed on the bottom of the sea to detect submarines, a towed array sonar system (TASS) used in vessels, etc. A passive sonar system acquires information, such as orientation, distance, moving velocity, etc., of a target by receiving noise radiated from a target, such as a submarine, etc., and identifies the target by analyzing a frequency spectrum of a received signal.

Active sonar systems acquire information of a target by artificially transmitting sound waves at the current positions thereof to the water or the sea bottom and receiving echo sound waves from the target. As representative active sonar systems, there are an echo sounder to measure a depth of water, a fish finder to detect a shoal of fish, a hull mounted sonar system installed in a vessel to detect a target, such as a submarine, etc. An active sonar system acquires information, such as distance, orientation, shape, moving velocity, etc., of a target by actively transmitting sound waves, such as pulse waves or frequency modulation waves, and receiving echoes from the target, such as the sea bottom, a shoal of fish or a submarine.

That is to say, a passive sonar system is not provided with the transceiver unit 160, and an active sonar system is provided with the transceiver unit 160.

As described above with reference to Equation 1, a refractive index of sound waves is a function of radius and, thus, the acoustic lens 10 is formed to have a concentric shape. The acoustic lens 10 does not necessarily have a circular shape but may have a semi-circular shape or a rectangular shape. Here, a refractive index of sound waves according to shapes of the acoustic lens 10 may be calculated by Equation 1 above.

If the acoustic lens 10 has a circular shape, when the acoustic lens 10 is divided into small sections, an upper limited frequency domain is raised as an interval between the refraction parts 130 is narrowed, and a lower limited frequency domain is lowered as the overall diameter of the acoustic lens 10 is increased. That is, an available wavelength area may be deduced through Equation 4 below.

$$b < λ < D or \frac{v}{D} < f < \frac{v}{b} \qquad [ Equation 4 ]$$

b is an interval between the respective refraction parts 130, and D is a diameter of the acoustic lens 10. Further, v is a background sound velocity which is about 340 m/sec in air and is about 1,500 m/sec in water.

If a 2D cylindrical sonar device is applied, a height of the acoustic lens 10 should be smaller than a wavelength of sound waves to be used so as to acquire a high resolution. Here, if the height of the acoustic lens 10 is greater than the wavelength of sound waves, resolution may be lowered. Of course, the size of the acoustic lens 10 or the interval between the refraction parts 130 may be changed as simple design change according to application environments and purposes of the acoustic lens 10.

For example, with reference to FIGS. 4 and 5, in an acoustic lens in which 2D cylindrical refraction parts 130 are disposed in a square type, if there are 15 (N=15) rows of the refraction parts 130, a ratio of the diameter (ϕ=2a) of the refraction parts 130 to the interval (ΔR=2b) between neighboring refraction parts 130 is deduced, as stated in Table 1 below.

TABLE 1

| i | $\frac{{φ}_{i}}{Δ R} = \frac{{a}_{i}}{b}$ |
|---|---|
| 1 | 0.8698 |
| 2 | 0.8680 |
| 3 | 0.8642 |
| 4 | 0.8584 |
| 5 | 0.8503 |
| 6 | 0.8396 |
| 7 | 0.8256 |
| 8 | 0.8077 |
| 9 | 0.7848 |
| 10 | 0.7553 |
| 11 | 0.5393 |
| 12 | 0.6650 |
| 13 | 0.5930 |
| 14 | 0.4854 |
| 15 | 0.2946 |

Here, the refraction part 130 of i=1 corresponds to the center of the acoustic lens 10, and the refraction part 130 of i=15 corresponds to the edge of the acoustic lens 10. Therefore, as exemplarily shown in FIG. 4, the refraction parts 130 located at the center of the acoustic lens 10 have the greatest diameter and the refraction parts 130 located at the edge of the acoustic lens 10 have the smallest diameter. Further, as can be determined from the ratio of the diameter of the refraction parts 130 to the interval between the refraction parts 130 stated in Table 1, the acoustic lens 10 is configured such that the central part of the acoustic lens 10 forms narrow paths (passages), along which sound waves pass, and thus increases the density of air, and the edge part of the acoustic lens 10 forms broad paths, along which sound waves pass, and thus decreases the density of air. On the contrary to the density of air, according to Equation 3 above, the central part of the acoustic lens 10 has the lowest velocity of sound waves and the edge part of the acoustic lens 10 has the highest velocity and, thus, sound waves are refracted within the refraction parts 130 and, when the sound waves reach the edge of the acoustic lens 10, the sound waves are focused onto one point of the other side of the acoustic lens 10 opposite the side of the acoustic lens 10, upon which the sound waves are incident, without aberration. Further, the refraction parts 130 may be formed of any material having different impedance from air or water so as to adjust the sizes of the paths (spaces), and have a circular, oval or polygonal, such as triangular, cross-section.

As a result of computer simulation of the acoustic lens 10 to which the above-described 2D cylindrical refraction parts 130 are applied, it may be confirmed that sound waves are refracted, as exemplarily shown in FIG. 6.

With reference to FIG. 6, sound waves having a frequency of 3,000 Hz (f=3,000 Hz) proceed from the left side of the acoustic lens 10, i.e., 9 o'clock, to the right side of the acoustic lens 10, i.e., 3 o'clock (with reference to directions and positions of the sensor parts of FIG. 3). Here, plane waves proceed at the left side of the acoustic lens 10 and, as the plane waves pass through the acoustic lens 10, the plane waves are gradually refracted, focused at 3 o'clock, and thus converted into spherical waves. Although FIG. 3 illustrates the sensor parts 140 as being disposed at respective hours of a clock, i.e., at an equal interval or at an equal angle (by an interval of an angle of 30 degrees), the sensor parts 140 may be disposed at more dense intervals or angles so as to achieve more precise sensing.

Change in the intensity of sound waves focused at 3 o'clock may be confirmed through difference in color change around the acoustic lens 10. Light blue and yellow plane waves at the left side of the acoustic lens 10 indicate an intensity of about −1 to 1 and, immediately after passing through the acoustic lens 10, deep blue and red spherical waves at the right side of the acoustic lens 10 indicate an intensity of about −3 to 3 and, thereby, it may be confirmed that the intensity of sound is increased by about 3 times.

Therefore, the output unit 170 may display the position of a target at 9 o'clock based on data transmitted from the sensor part 140 at 3 o'clock and thus display a distance from the target and a moving direction or turning direction of the target, thus allowing a user to precisely confirm the position and direction of the target around the user. Of course, although not shown in the drawings, in addition to a visual display device to visually output information of a target, the output unit 170 may be used to audibly output a data value read from a speaker (not shown), a buzzer or the sensor parts 170. Of course, the output unit 170 may audibly and visually output information of a sound source so that a mate at his/her current position may confirm movement of the sound source through an analog method or a digital method.

If such an acoustic lens 10 is minimized and ultrasonic waves are used, divers may confirm a target using sound waves under the sea which light does not reach, in the same manner as a dolphin. For example, after the output unit 170 is mounted in diver's swimming goggles and the diver wears the acoustic lens 10 on his/her head or back, when the transceiver unit 11 transmits ultrasonic waves in a direction of his/her view, the acoustic lens 10 senses echo ultrasonic waves, the output unit 170 displays information on the swimming goggles and, thus, the diver may visually confirm a target even in a lightless space.

Further, if sound waves from two or more sound sources enter the acoustic lens 10, the controller 150 may control the output unit 170 so as to simultaneously output data sensed by the sensor parts 140. Therefore, if a user has difficulty securing a clear view, the user may precisely sense whistles simultaneously blown from two or more targets and detect directions thereof or distances therefrom and, thus, even an amateur may easily detect the targets.

As is apparent from the above description, a sonar device in accordance with the present invention has effects, as follows.

First, even if it is difficult to secure a clear view in water or on the water, the sonar device may precisely identify an object of a short distance or a long distance.

Second, the sonar device may visually or audibly confirm direction, distance or movement of a sound source and thus facilitate intuitive decision.

Third, the sonar device may generate sound waves and receive echo sound waves from an object, thus being used as both an active sonar device and a passive sonar device.

Fourth, the sonar device may be minimized and reduced in weight and thus be applied to large vessels, small ships or diver's swimming goggles.

Fifth, the sonar device may be manufactured to have a simple configuration and thus reduce manufacturing costs and be easily popularized.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A sonar device comprising:
an upper plate;
a lower plate disposed in parallel with the upper plate so as to be spaced apart from the upper plate;
a plurality of refraction parts connected between the upper plate and the lower plate so as to refract sound waves;
a plurality of sensor parts disposed between the upper plate and the lower plate so as to sense the sound waves passed through the refraction parts; and
an output unit to visually or audibly output an intensity or a direction of the sound waves sensed by the sensor parts.

2. The sonar device according to claim 1, wherein the refraction parts are formed of a material having different impedance from air or water.

3. The sonar device according to claim 1, wherein the refraction parts refract the sound waves a medium passing between the refraction parts by changing an elastic modulus or density of the medium.

4. The sonar device according to claim 1, wherein the diameters or cross-sectional areas of the refraction parts are gradually decreased in a direction from a central region of a space between the upper plate and the lower plate to an edge region of the space, or paths of the refraction parts to pass the sound waves are gradually broadened in the direction from the central region of the space to the edge region of the space.

5. The sonar device according to claim 4, wherein refractive indexes of the refraction parts are gradually decreased in the direction from the central region of the space between the upper plate and the lower plate to the edge region of the space so that a velocity of the sound waves is increased and the sound waves introduced into one side of the space is collected at the other side of the space.

6. The sonar device according to claim 1, wherein the refraction parts are formed to have a column shape connecting a lower surface of the upper plate to an upper surface of the lower plate, and have a circular, oval or polygonal, such as triangular, cross-section.

7. The sonar device according to claim 1, wherein the sensor parts are located close to side surfaces of the refraction parts at an edge region of a space between the upper plate and the lower plate, and are disposed at an equal interval or at an equal angle.

8. The sonar device according to claim 7, further comprising a controller configured to receive sound wave signals sensed by the sensor parts located at designated positions, to convert the sound wave signals into electrical signals and then to transmit the electrical signals to the output unit.

9. The sonar device according to claim 8, further comprising a transceiver unit configured to transmit sound waves at a current position of the sonar device and then to cause echo sound waves from a target to be received by the refraction parts.

10. The sonar device according to claim 9, wherein the controller is operated through at least one of an active control method to transmit sound waves through the transceiver unit and to receive echo sound waves, and a passive control method to receive sound waves generated from the outside.

11. The sonar device according to claim 9, wherein, if the controller is operated through an active control method, the controller controls the output unit to output at least one of a distance between a current position of the sonar device and a target and a direction and a velocity of the target.
